(19) United States
(12) Patent Application Publication
(10) Pub. No.: US 2006/0245858 A1
(43) Pub. Date: Nov. 2, 2006

(54) Apparatus for forming a sequence of load carriers by means of a temporary store, and method for temporary storage

(76) Inventor: Heiko Suess, Graz (AT)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/330,514

(22) Filed: Jan. 12, 2006

(30) Foreign Application Priority Data
Jan. 18, 2005 (DE) 10 2005 002 348.7

(51) Int. Cl. B65G 65/00

(52) U.S. Cl. 414/277

(57) ABSTRACT

In order to permit a temporary storage with a simultaneously high number of storage places and high throughput capacity, a rack (1) which may include mutually opposite rack units (1a, 1b), in the rack aisle of which a vertically movable lifting bar (7) is arranged. Two load suspension means (6a, 6b) may be provided for removing the load carriers (2) and are movable horizontally at the lifting bar (7). Removed load carriers (2) are deposited in the respectively desired sequence on a conveyor (8), which is connected fixedly to the lifting bar (7) and the conveying direction of which can be reversed, and may then be delivered batchwise onto a removal device (5) for further transportation. The rack levels (3) of the rack (1) may be accumulating conveyors, with it being possible for the load carriers (2) to be placed into the store from the end side of the rack (1) via a lifting device (9a, 9b) without using the load suspension means (6a, 6b). The method and apparatus may be used, by way of example, to facilitate the packing of goods order picked on load carriers (2), the load carriers (2) belonging to an order are first of all collected in a temporary store and are then conveyed for dispatch in a predetermined sequence favorable for packing.

### BACKGROUND OF THE INVENTION

The invention relates to an apparatus for temporary storage of load carriers by means of a temporary store, designed as a rack, with a plurality of rack levels and to a method for temporary storage of load carriers.

During the order picking of orders, the goods belonging to an order are frequently collected on load carriers which usually have a uniform shape and are designed, for example, as box-shaped containers. In the case of extensive orders, a single load carrier is frequently insufficient for this, and a plurality of load carriers are required. The collecting of the goods is frequently undertaken by different order pickers at different times at different order picker locations. The filled load carriers which belong to a common order are therefore available at different times for assembling together by dispatch. However, an order dispatch sequence requires not only the complete provision of all items of an order, but as far as possible also a suitable sequence of the individual articles in respect of the designated transport packagings. This means that the articles to be packaged should be provided successively in accordance with their size and with respect to their packaging requirements (e.g., fragility) to the particular worker at the particular dispatch workstation in such a manner that they can be successively processed making as advantageous use as possible of the useful volume of the particular packaging (e.g., cardboard box) without substantial rearrangements and temporary storage processes having to be undertaken at the packaging workstation.

To solve this problem, special temporary stores are known which are arranged with the effect of buffer stores between the order picker area and the dispatch area of a store and temporarily receive the load carriers belonging to an order until all of the items of the particular order have been order picked, and then discharge these temporarily stored load carriers again for dispatch in a respectively desired sequence matching the dispatch requirements.

For example, EP 0 860 382 B1 discloses sorting buffer stores which are also referred to as sequencing towers. These are constructed in the form of a tower in which there are two rows of individual storage places arranged one above the other for load carriers. The two vertical rows of storage places lie at a distance opposite each other in a mirror-inverted manner, with a lifting device which can transport load carriers to the individual storage places being provided in the intermediate space enclosed by them. In a basic position of the lifting device, this is part of the conveying path on which the ready order picked load carriers are supplied to the sequencing tower for temporary storage or on which the load carriers belonging to an order can be transported to the dispatch area as soon as all of the load carriers belonging to the particular order are available in the temporary store. Since, during the removal of the individual load carriers, the lifting device permits completely random access to all of the load carriers, a predetermined sequence can easily be kept to during the removal. A comparatively high throughput capacity is characteristic of this type of sequencing tower; by contrast, however, the storage capacity available for temporary storage is very restricted, thus requiring a correspondingly large number of these devices which are costly with regard to investment costs.

Another type of temporary store for forming a sequence is disclosed in DE 299 12 230 U1. This temporary store comprises a series of similar storage modules which are arranged directly next to one another in a line. Each storage module comprises two opposite storage racks each having a multiplicity of rack levels, with each storage level having a plurality of storage places situated next to one another for load carriers. A respective storage aisle is arranged between the opposite storage racks and arranged in the storage aisle is a lifting bar which extends over the entire length of the particular module and is movable vertically over the entire height of the storage rack. A load suspension means which is movable in the horizontal direction on the lifting bar is arranged on the latter. The task of the load suspension means is to bring a load carrier which is to be temporarily stored to a free storage place in a rack level and to remove it again from this storage place in each case when required. The load carriers to be newly placed into the store are conveyed in each case via a placing-in path and a belt conveyor adjoining thereto through the longitudinal side of a storage rack into the working region of the load suspension means assigned in each case to this storage rack, and are temporarily stored. The removal takes place in a correspondingly reversed manner with the aid of the load suspension means and a further belt conveyor which, in turn, extends through the particular storage rack on the longitudinal side thereof and leads to a removal path. The placing-in path and the removal path are arranged on levels spaced apart from each other.

In DE '230, it is essential that each module has a plurality of removal paths which are in each case designed as accumulating conveyors. The load suspension means can deposit the load carriers of an order, which load carriers belong to an order and are temporarily stored in the particular module, individually onto these accumulating conveyors. All of the removal paths run parallel to one another and end at a distance before a conveying path which leads to the dispatch area and runs transversely to the removal paths. Arranged between the removal paths and this conveying path is a movable transferrer which is designed in the sense of a conveying curve and optionally produces a conveying connection between any desired removal path and the conveying path leading to the dispatch, so that a load carrier standing on the removal path can be transferred to the conveying path transporting it away. The transferrer is therefore capable of transferring the load carriers to be removed in a desired sequence onto the conveying path transporting them away by approaching the particular removal paths in this predetermined sequence. In the case of this manner of designing a temporary store for forming a sequence, there is usually a high storage capacity, i.e., a multiplicity of storage places for load carriers. By contrast, limitations are to be seen with regard to the throughput capacity.

### SUMMARY OF THE INVENTION

The present invention provides a temporary store which is distinguished both by a high storage capacity and also by a high throughput capacity with a comparatively low investment outlay. In addition, a method is provided for the temporary storage of load carriers, the implementation of which is cost-effective and highly efficient.

The apparatus according to aspects of the invention for forming a sequence of load carriers is of importance in particular within the context of the order picking of orders and subsequent dispatch. It has a temporary store designed as a rack with a plurality of rack levels in which the individual load carriers can be temporarily stored. A feed-in device and a removal device are provided for transporting the load carriers to the store and away from the store. Furthermore, at least one load suspension means is provided which is movable horizontally along the rack on a lifting bar, which is vertically movable on a longitudinal side of the rack, and causes load carriers to be taken out of the particular storage point in the rack for transporting away by the removal device. Furthermore, this apparatus may have a device which provides the load carriers to be removed in a desired sequence on the removal device. The functions of the lifting bar and of the at least one load suspension means are controlled by an electronic controlling means.

According to an aspect of the invention, a conveyor is part of the device for forming a sequence of the load carriers to be removed, this conveyor extending over the length of the rack in the working region of the at least one load suspension means and furthermore being connected in terms of conveying to the removal device. The electronic controlling means is set up to control this conveyor and the at least one load suspension means in such a manner that the load carriers removed from the rack lie on the conveyor in the desired sequence.

Even if the apparatus according to the invention were to be implemented with an individual storage rack row, the temporary store may be constructed from two rack units lying opposite one another in parallel leaving a rack aisle, the lifting bar and the conveyor being arranged in the storage aisle. In this case, in the interests of a high throughput capacity, the conveyor may be arranged fixedly on the lifting bar, i.e., may be movable vertically together with the latter. For further increase in capacity, as far as possible two load suspension means which can be operated independently of each other but taking collision protection into consideration should be arranged on the lifting bar.

The feed-in device for feeding in load carriers newly to be temporarily stored may be fitted on an end side of the rack. As a result, a loss of storage places which would arise if the feed-in device were arranged on the longitudinal side of the rack is avoided. The feed-in device may be in the form of two separate conveying units, each conveying unit being assigned in each case to a unit of the rack. Since the feed-in device, which can be designed, for example, in the form of a customary band, belt, roller or chain conveyor, ends in a certain plane on the end side of the rack, a lifting device may be provided, for example, in the form of a conveying lift, on the end side of the rack which connects the feed-in device to the individual levels of the rack. Of course, in the case of a rack comprising two units, each unit may be provided with a lifting device of this type.

The removal device may be arranged in such a manner that, in a basic position of the lifting bar, it directly adjoins the conveyor arranged on the lifting bar, so that no additional handling means are necessary for transferring load carriers to the removal device.

The individual rack levels of the rack may be designed in each case as accumulating conveyors, in particular as driven accumulating conveyors, the conveying direction pointing from the feed-in device to the removal device. In this manner, the load carriers to be newly temporarily stored can be transferred via the above-mentioned lifting device without the assistance of one or more load suspension means directly onto the rack levels and transported to a free storage space. The load suspension means is therefore always restricted with regard to its function just to the removal process. The placing into the store takes place completely independently of it.

The temporary store may be provided with at least 10, in particular at least 16, rack levels, so that a sufficient number of storage places can be provided in the temporary store.

In order to enable a correct formation of a sequence, the drive for the conveyor, on which the load suspension means deposits the load carriers to be removed in each case, may be reversible.

A method according to the invention for temporary storage of load carriers is based on a method, in which the load carriers are fed in via a feed-in device to a temporary store having a plurality of rack levels and are removed in a desired sequence onto a removal device. In this case, the stored load carriers are removed again from the particular storage points of the rack levels by means of at least one load suspension means, which is movable horizontally on a lifting bar and vertically together with the latter. For a method of this type, the invention makes provision for the load carriers to be removed to be in each case picked up by the at least one load suspension means from the storage place in the rack and to be deposited on a depositing surface designed as a conveying surface of a conveyor. In this case, a plurality of load carriers can be positioned in the desired sequence on the depositing surface by temporary actuation of the drive of the conveyor and temporarily coordinated actuation of the at least one load suspension means taking account of the particular position of the storage points of the load carriers to be removed in the rack levels. The load carriers which are removed to this extent and are situated next to one another are delivered to the removal device by actuation of the conveyor. At least up to four, in particular at least up to six, load carriers may be simultaneously placed in the desired sequence on the conveyor and then transferred batchwise to the removal device.

In the case of a fixed connection of the conveyor to the lifting bar, the delivery of load carriers to be removed to the removed device takes place after the lifting bar has been moved into a vertical position in which the conveyor is connected in terms of conveying to the removal device.

In order to be able to place a relatively large number of load carriers in the correct sequence on the conveyor, the conveying direction can be reversed during the successive loading of the conveyor.

The placing of load carriers into the store may be carried out by means of a lifting device arranged on the end side of the rack. This enables all of the rack levels to be serviced independently of the one or more load suspension means and may be provided in combination with an arrangement of the storage points of the rack levels on accumulating conveyors on which the originally adopted storage place is displaced as time passes in accordance with the conveying movement. The actual storage location within a rack level can easily be updated by the electronic controlling means of the system according to the invention by recognition of the particular path of movement of the accumulating conveyor, with the result that the travel data required for the load suspension means in the case of removal can readily be made available.

These and other objects, advantages and features of this invention will become apparent upon review of the following specification in conjunction with the drawings.

### BRIEF DESCRIPTION OF THE DRAWINGS

The invention is explained in more detail below with reference to the exemplary embodiment illustrated in merely schematized form in the figures, in which:

FIG. 1 shows an apparatus according to the invention with two rack units in plan view;

FIG. 2 shows the apparatus according to FIG. 1 in side view; and

FIG. 3 shows the apparatus according to FIG. 2 in an end view.

### DESCRIPTION OF THE PREFERRED EMBODIMENT

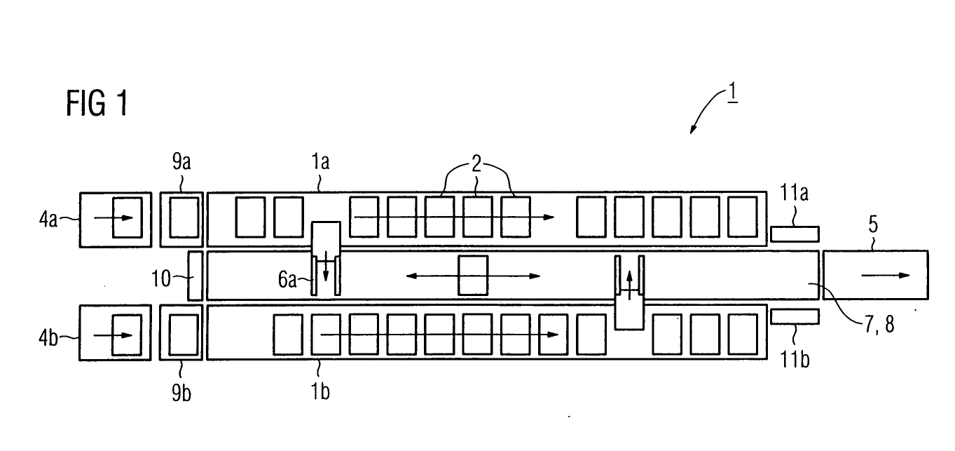

The exemplary embodiment, illustrated in three views in FIGS. 1-3, for the invention shows a rack 1 which comprises two units 1a, 1b which are constructed identically and lie opposite each other at a distance in parallel and in a mirror-inverted manner leaving a storage aisle. Each rack unit 1a, 1b is assigned a respective conveying unit 4a, 4b of a feed-in device 4 which is arranged on the left end side of the rack 1 and serves to feed in load carriers 2 to be newly temporarily stored at a free storage point of one of the rack levels 3 of the rack 1. The individual rack levels 3 may be designed as accumulating conveyors, so that the filling of the storage points can take place in an extremely simple and effective manner via a lifting station 9 which is arranged directly between the feed-in device 4 and the end side of the rack 1.

Corresponding to the division of the feed-in device 4 and of the rack 1 into two units in each case, the lifting station 9 is also divided into and assigned to two units 9a, 9b. The lifting station 9 expediently comprises a conveying device which is optionally movable in its vertical position to the vertical position of the feed-in device 4 and the vertical positions of the rack levels 3. In principle, however, other solutions would also be conceivable for this, for example, the use of a robot as transferrer for the load carriers 2 to be temporarily stored. The accumulating conveyors are expediently driven by a motor, but could also basically be designed as gravity conveyors.

Arranged in the region of the storage aisle between the rack units 1a, 1b is a lifting bar 7 which extends over the entire length of the rack 1 and is vertically movable on guide pillars 10, 1a, 11b which are arranged on the left and right end side of the rack 1. A conveyor 8 is arranged fixedly at or on this lifting bar 7, i.e., is movable together with the lifting bar 7. The conveyor 8 has a motor drive which is preferably reversible, in order to be able temporarily to reverse the conveying direction, and which expediently has a drive which can be controlled to the effect that the electronic controlling means (not illustrated) of the rack 1 that controls all of the drives is precisely informed about the path of movement of the conveyor 8. This could be ensured, for example, by means of a stepping motor, servo motor, or the like. This is necessary so that the controlling means is informed at all times about the actual position of the load carriers 2 resting on the conveyor. Of course, it would also be possible to determine these data as an alternative or redundant to security via a corresponding sensor arrangement (e.g., light barriers or video system).

Conveyor 8 also extends over the entire length of the rack. Furthermore, at least one, in the case illustrated, two load suspension means 6a, 6b are connected to the lifting bar 7 in such a manner that they are movable horizontally over the length thereof. These load suspension means 6a, 6b can be designed in a corresponding manner to the load suspension means of customary storage and retrieval units, i.e., for example, can have extendable (telescopic) gripper jaws, suction grippers or band, belt, chain, roller conveyors, or the like, moving under the particular load carrier 2. On the right end side of the store 1, a removal device 5 adjoins the lifting bar 7 and its conveyor 8, which removal device serves to further transport removed load carriers 2 for example, to a dispatch area (not illustrated).

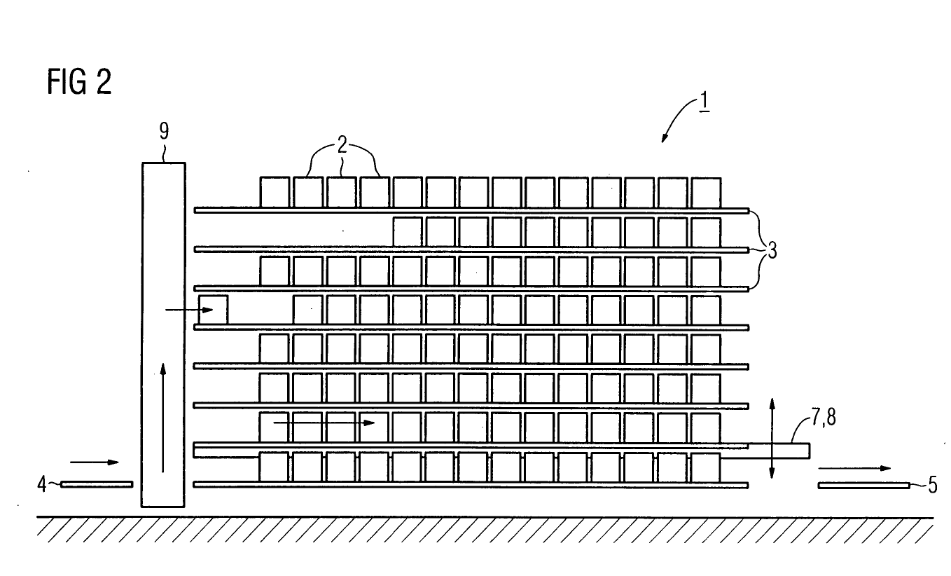

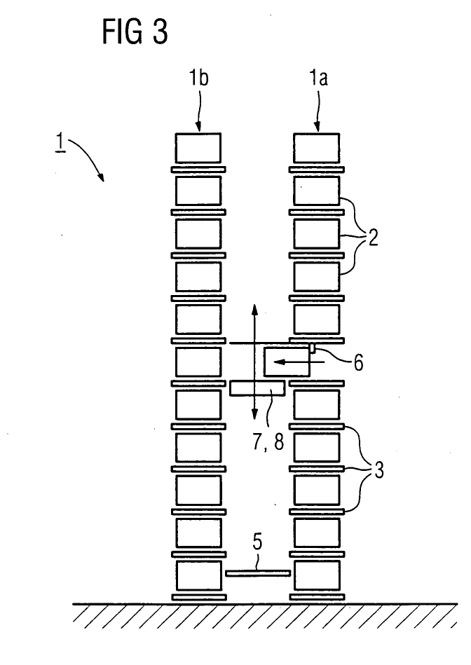

It can be seen from FIG. 2 that the lifting bar 7 has first of all to be lowered together with the conveyor 8 to the vertical position of the removal device 5 in order to discharge load carriers 2. The manner in which a gripping device of the load suspension means 6 pulls a temporarily stored load carrier 2 out of a storage place of a rack level 3 onto the conveyor 8 of the lifting bar 7 can be seen from the end view of FIG. 3.

The manner of operation of the apparatus according to the invention for temporarily storing load carriers is as follows: the load carriers 2 which are filled with different articles, for example, such as within the context of order picking, and which are expediently designed as unit storage boxes can be fed to the rack 1 in any desired sequence via the feed-in units 4a, 4b. They are conducted to a free storage place on a rack level 3 via the units 9a, 9b of the lifting station 9. It is recommended in this case to design the electronic controlling means in such a manner that, if corresponding free storage capacity is available, it deposits the load carriers 2 which belong in each case to the same order on the same rack level 3 in order to accelerate the later removal. However, this is in no way absolutely necessary. Since the rack levels 3 are designed in each case as accumulating conveyors, the load carriers 2 deposited by the lifting station 9 reach their storage place (accumulating place) for temporary storage solely by means of the conveying movement of the particular accumulating conveyor. Of course, the controlling means is informed about which load carrier 2 is in each case at which position of the accumulating conveyor.

As a consequence of temporarily stored load carriers 2 being taken away, the position of a load carrier 2 on the accumulating conveyor can constantly change. This is correspondingly updated in the controlling means. The load suspension means 6a, 6b are therefore in no way concerned with the operations involving the placing into storage of load carriers 2 to be newly temporarily stored, but rather are responsible exclusively for removing the load carriers 2. The load carriers 2 belonging to an order are fetched by the two load suspension means 6a, 6b, respectively, out of the particular storage places of the storage levels 3 and deposited on the conveyor 8 in a sequence corresponding to the specification for transportation to the dispatch area.

However, it is not absolutely necessary for the removal of the load carriers from the storage levels 3 to take place precisely in this desired sequence. On the contrary, the two load suspension means 6a, 6b can take over the load carriers 2 in such a manner that they require routes which are as short as possible in order to approach the particular position. By moving the conveying surface of the conveyor 8 forwards or backwards (indicated by a double arrow in FIG. 2), the position of the load carriers 2 already situated on the conveyor 8 can be set forward or backward depending on requirements in order to maintain the correct sequence. If the load carriers 2 belonging to an order are all deposited on the same storage level 3, the lifting bar 7 does not need to be moved during the loading of the conveyor 8 with the load carriers 2.

If, by contrast, the associated load carriers 2 are distributed over different storage levels 3, then they have to be approached successively by lowering or rising of the lifting bar 7. Expediently, the load suspension means 6a, 6b are designed in such a manner that they can in each case remove load carriers 2 from the two rack units 1a, 1b. This is advantageous in particular with regard to security against failure (redundancy). Of course, provision may also be made for it to be possible for each load suspension means 6a, 6b to service only one of the two rack units 1a, 1b in each case. As soon as the load carriers 2 belonging to an order are collected on the conveyor 8, the lifting bar is brought into a vertical position corresponding to the removal device 5, if it has not already reached this beforehand, and the removed load carriers 2 are then transferred onto the removal device 5 by actuation of the conveyor 8.

Of course, it is also possible that an order having a very great number of load carriers 2 which do not have space together on the conveyor 8 is removed in a plurality of batches. However, the controlling means ensures that the desired sequence is maintained over all of the batches and that the batches can be delivered in immediate succession in order not to cause any delays during dispatch. In the case of orders which comprise only a very few load carriers, it is also possible to collect the load carriers 2 for a plurality of orders on the conveyor 8 in the particular sequence and then to deliver them together in one batch onto the removal device 5 in order to keep the throughput capacity overall at a high level.

A design of the apparatus according to the invention that is suitable for practical use may have, for example, a rack length and lifting-bar length of approximately 7.5 m. In the case of load carriers which have the size of frequently used storage containers, this corresponds to a number of approximately 14 accumulating places per rack level. In the case of a rack height of 10 meters, a rack of this type comprises, for example, approximately 16 rack levels. If the rack is equipped with two rack units, this means a storage capacity for in total 14×16×2=448 load carriers. The controlling means may be designed in such a manner that at maximum just six to seven load carriers may be simultaneously accommodated on the conveyor of the lifting bar. This reduces the requirements imposed on the accuracy of the positioning of the load carriers 2 on the conveyor 8 considerably and at the same time facilitates the formation of a sequence, since in this manner, when required, individual load carriers can more easily be positioned between in each case two load carriers which have already been removed. By completely decoupling the placing into storage and removal operations, an extremely high throughput capacity can be ensured which, for example, for the application described above, lies at over 500 double storage operations per hour. At the same time, a high capacity of temporary storage places is achieved. The investment outlay required for this is considerably lower in comparison to the alternative solutions known from the prior art.

Changes and modifications in the specifically described embodiments can be carried out without departing from the principles of the invention which is intended to be limited only by the scope of the appended claims, as interpreted according to the principles of patent law including the doctrine of equivalents.

1. An apparatus for forming a sequence of load carriers by means of a temporary store formed as a rack with a plurality of rack levels in which the load carriers can be temporarily stored, comprising:
a feed-in device and a removal device;
a lifting bar being movable vertically on a longitudinal side of the rack and at least one load suspension device which is movable horizontally along the rack at said lifting bar, wherein load carriers can be taken out of a particular storage point in the rack for transporting away by said removal device;
an electronic control, said control controlling the functions of said lifting bar and of said at least one load suspension device;
a sequencing device which causes the load carriers to be removed in a desired sequence on said removal device, wherein said sequencing device comprises a conveyor which extends over the length of the rack in a working region of the at least one load suspension device and is adapted to be aligned with said removal device; and
said electronic control controlling said conveyor and said at least one load suspension device in such a manner that the load carriers removed from the rack lie on said conveyor in a desired sequence.

2. The apparatus as claimed in claim 1, wherein the temporary store comprises two units of the rack lying opposite one another in parallel thereby defining a storage aisle, said lifting bar and said conveyor being arranged in said storage aisle.

3. The apparatus as claimed in claim 2, wherein said conveyor is arranged fixedly on said lifting bar.

4. The apparatus as claimed in claim 3, including at least two load suspension means arranged on said lifting bar.

5. The apparatus as claimed in claim 4, wherein said feed-in device is arranged on an end side of the rack.

6. The apparatus as claimed in claim 5, wherein said feed-in device comprises two conveying units, and wherein each unit of the rack is assigned one of said conveying units.

7. The apparatus as claimed in claim 6, wherein said feed-in device is connected to the rack via a lifting device.

8. The apparatus as claimed in claim 7, wherein said lifting device comprises two lifting devices, each of which is respectively assigned to one of said units of the rack.

9. The apparatus as claimed in claim 8, wherein said removal device directly adjoins the conveyor in a basic position of said lifting bar.

10. The apparatus as claimed in claim 9, wherein the rack levels comprise accumulating conveyors.

11. The apparatus as claimed in claim 10, wherein said accumulating conveyors are driven accumulating conveyors, the conveying direction of which runs from said feed-in device to said removal device.

12. The apparatus as claimed in claim 10, wherein said temporary store comprises at least 10 rack levels.

13. The apparatus as claimed in claim 1, wherein the conveying direction of said conveyor is reversible.

14. The apparatus as claimed in claim 1, including at least two load suspension means arranged on said lifting bar.

15. The apparatus as claimed in claim 14, wherein said feed-in device is arranged on an end side of the rack.

16. The apparatus as claimed in claim 15, wherein said feed-in device comprises two conveying units, and wherein each unit of the rack is assigned one of said conveying units.

17. The apparatus as claimed in claim 2, wherein said feed-in device comprises two conveying units, and wherein each unit of the rack is assigned one of said conveying units.

18. The apparatus as claimed in claim 1, wherein said feed-in device is connected to the rack via a lifting device.

19. The apparatus as claimed in claim 18, wherein said lifting device comprises two lifting devices, each of which is respectively assigned to one of said units of the rack.

20. The apparatus as claimed in claim 1, wherein said removal device directly adjoins the conveyor in a basic position of said lifting bar.

21. The apparatus as claimed in claim 20, wherein the rack levels comprise accumulating conveyors.

22. The apparatus as claimed in claim 21, wherein said accumulating conveyors are driven accumulating conveyors, the conveying direction of which runs from said feed-in device to said removal device.

23. A method for temporarily storing load carriers which are fed in via a feed-in device to a temporary store having a plurality of rack levels and are removed in a desired sequence of load carriers onto a removal device, said method comprising:
removing the stored load carriers by means of at least one load suspension device, which is movable horizontally at a lifting bar and vertically together with said lifting bar, from a particular storage points of the rack levels;
lifting the load carriers to be removed by the at least one load suspension device and depositing the loading carriers on a conveying surface of a conveyor;
positioning a plurality of load carriers in a desired sequence on the conveying surface by temporary actuation of the drive of said conveyor; and
temporarily coordinating actuation of the at least one load suspension means taking account of the particular position of the storage points of the load carriers to be removed in the rack levels, and conveying removed load carriers being situated next to one another to the removal device by actuation of said conveyor.

24. The method as claimed in claim 23, including arranging said conveyor fixedly at or on said lifting bar, and delivering the load carriers to be removed to said removal device after said lifting bar has been moved into a particular vertical position and aligning said conveyor with said removal device.

25. The method as claimed in claim 24, wherein the conveying direction of said conveyor is temporarily reversed during successive loading of said conveyor in order to form the sequence of load carriers.

26. The method as claimed in claim 25, including arranging the storage positions of the rack levels on an accumulating conveyor.

27. The method as claimed in claim 15, including providing a lifting device arranged on the end of the rack and placing load carriers into the store with said lifting device.

28. The method as claimed in claim 27, including depositing at least four load carriers generally simultaneously in the desired sequence on said conveyor and transferring the load carriers batchwise to said removal device.

29. The method as claimed in claim 23, including temporarily reversing the conveying direction of said conveyor during successive loading of said conveyor in order to form the sequence of load carriers.

30. The method as claimed in claim 23, including arranging the storage positions of the rack levels on an accumulating conveyor.

31. The method as claimed in claim 23, including depositing at least four load carriers generally simultaneously in the desired sequence on said conveyor and transferring the load carriers batchwise to said removal device.
